(19) United States
(12) Patent Application Publication
(10) Pub. No.: US 2019/0300745 A1
(43) Pub. Date: Oct. 3, 2019

(54) SEALABLE CONTAINER FOR FOOD WASTE COLLECTION

(71) Applicant: GrubTubs, Inc., Portland, OR (US)

(72) Inventor: Robert OLIVIER, Austin, TX (US)

(21) Appl. No.: 16/370,700

(22) Filed: Mar. 29, 2019

Related U.S. Application Data
(60) Provisional application No. 62/649,841, filed on Mar. 29, 2018.

(51) Int. Cl. C09D 127/12; B65F 1/02; B65F 1/14; B65F 1/16

(52) U.S. Cl. CPC C09D 127/12; B65F 1/02; B65F 1/1484; B65F 1/1615; B65F 2250/114; B65F 2001/1676; B65F 2210/138; B65F 2210/167; B65F 2001/1489

(57) ABSTRACT

Methods, systems, and apparatus, including food waste removal system employed to eliminate food waste from trash for food permitted establishment. In one aspect, a method for evacuating food waste from a food permitted establishment includes providing a sealable container, the sealable container comprising a vessel and a lid, the vessel comprising a base portion and a vertical sidewall forming a closed bottom, an inner surface, and an open top, the inner surface having been exposed to a chemical to form a coating resistant to molecule permeation, the lid configured to form a seal preventing oxygen from entering, distributing the sealable container within the food permitted establishment, filling the vessel with the food waste, sealing the vessel with the lid to form the seal, placing the sealable container on a delivery vehicle, and removing the sealable container filled with food wastes from the food permitted establishment with the delivery vehicle.

### CROSS REFERENCE

This application claims the benefit of U.S. Provisional Application No. 62/649,841, filed Mar. 29, 2018, which application is incorporated herein by reference in its entirety.

### BACKGROUND OF THE INVENTION

The food industry throws away a lot of food (food waste) and traditional programs to recycle food waste have low levels of participation because in the collection container used. For example, a recent article in the New York Times' discussed why compost programs do not work. One quote from the article states that “most of the people we know don't compost because of cleaning the honestly somewhat gross outdoor brown bin.” The article stated that, with a 10 percent participation rate, the city of New York was collecting compost at $350 plus a ton. Moreover, the city had spent $15 million on the service and ended up selling $50 k in compost year. AS an example, even if the food waste was used as animal feed, it would only be worth about $6,000,000 and still cost $4,000,000 to make. The 10 percent participation rate was the main cause hurting the program cited in the article. Imagine if the participation rate was raised to 50 percent or even or 90 percent. A 30$ million feed program would be a solution with a $15 million collections expense. 1 Collins, Lisa M (Nov. 9, 2018) The Pros and Cons of New York's Fledgling Compost Program. The New York Times. Retrieved for https://www.nytimes.com/2018/11/09/nyregion/nyc-compost-zero-waste-program.html.

### SUMMARY OF THE INVENTION

Typical, food waste is collected in drums or compost bins. In many instances, these bins are larger than 100 liters, which is convenient for waste haulers, but makes the drums heavy and difficult to transport for the kitchen staff. For example, moving a bin from the kitchen to where it is stored for pickup by a single individual is almost impossible without a mechanical aid. Also these large bins are difficult to seal and often stink in less than 24 hours. As such, these bins cannot be placed inside a food permitted area and thus must be kept outside. Additionally, as a kitchen gets busy, there is often no time to bring food waste outside for disposal in the large bins. Thus, a large portion of food waste is diverted to a trash receptacle. This leads to low adoption rates for the composting of food waste and trash dumpsters that contain enough food waste to remain stinky (e.g., the container have a pungent odor) and need to be emptied frequently. Moreover, the large composting bins are smelly so they attract pest and flies. Also, depending on the weather, the large bins can heat up when they are left outside. This heating can cause the bins to become thermophilic and thus harbor pathogens. The size of these bins also increases the risk of food borne pathogens makes it risky to repurpose discarded food waste for feeding animals. Thus, these described issues limit the use of the large bins exclusively to composting.

The described food waste removal system may be employed to eliminate food waste from trash for food permitted establishment, such as kitchens, restaurants, and grocery stores. The described food waste removal system uses reusable, sealable containers increase participation rate in the recycling food waste. The sealable containers described herein, solve the odor issues described above as well as provide a more convenient container than a trash bin for the disposal of food waste. To solve the odor issues, the described sealable containers include a lid that can be place over a vessel that is used to collect the food waste. The lid forms an airtight seal once placed on the vessel. The sealable containers can be stacked and stored for later transport to, for example, a composting facility where the contents of the containers can be emptied. The sealable containers can be cleaned, returned, and used for to collect additional more food waste. The sealable containers provide a sturdy bin that also prevents spills and makes it difficult for rodents and pests to access the food waste. Additionally, in some embodiments, the inside surfaces of the sealable containers as well as the bottom surface of the lid can be infused with a chemical, such as fluorine, to create a barrier coating to both odor and discoloration caused by repeated exposure to food waste. In some embodiments, both the outside surfaces and the inside surfaces of the vessel as well as the lid (either both top surface 105 and the bottom surface 103 or just the bottom surface 103) are exposed to chemical to create the coating on all surfaces of the sealable containers. Using anti-microbial agents, such as nano phase silver particles, or scents may not prevent the odor from permeating the material, such as plastic, used to form the sealable containers after repeated exposure to food waste. This permeated odor may not be removable by cleaning either. The barrier coating provides a long term solution to this issue and, in some embodiment, increases the number of uses to 200 or 300 per container, as opposed to twenty or thirty uses, thus decreasing overall cost of the described food waste removal system. Moreover, the sealable containers are also easier to clean and dry with the barrier coating.

In some embodiments, the described food waste removal system employs clean, re-useable sealable containers. In some embodiments, each of these sealable containers includes a vessel and is equipped with a lid. In some embodiments, the lid is configured to create an airtight seal that prevents discarded food from wasting. In some embodiments, the sealable containers are size to hold up to 50 liters in volume. In some embodiments, the sealable containers are size to hold up to 200 liters in volume. Such a small size allows the containers to be deployed within the described food waste removal system placed directly within food permitted establishment, such as an industrial kitchen. Once a vessel is filled with food waste, the lid can be placed on the vessel to seal the container. The sealed container can be stacked for simplified logistics for composting, industrial use, or animal feed.

The sealed containers also better isolate odors when stored and stacked outside of a food permitted establishment. Use of the sealable containers within a food waste removal system may greatly reduce the frequency of trash service as much of the generated food waste is captured within the sealable containers. By employing the food waste removal system, a restaurant, for example, can easily recover 90 percent of the food in the sealable containers while leaving almost no food in the trash. Thus, allowing the restaurant to recycle more and have less trash pickups. Furthermore, because food is collected in many smaller containers throughout various places of the restaurant, more food is captured. The sealed containers can also be used to collect food for feeding livestock (e.g., chickens and pigs) directly or for feeding insects, such as black soldier flies, that may be fed to the livestock. In some embodiments, the food waste removal system may be employed for food waste management.

In one aspect, disclosed herein are methods for evacuating food waste from a food permitted establishment, the method comprising: providing at least one sealable container to the food permitted establishment, wherein the at least one sealable container comprises a vessel and a lid, wherein the vessel comprises a base portion and at least one vertical sidewall forming a closed bottom, an inner surface, and an open top for receiving the food waste, the inner surface having been exposed to a chemical for a period of time to form a coating resistant to molecule permeation, and wherein the lid is configured to attached to a top portion of the at least one vertical sidewall to cover the open top and form a seal preventing oxygen from entering the sealable container; distributing the at least one sealable container within the food permitted establishment where food is going to waste; filling the vessel of the at least one sealable container with the food waste leaving room for gases; sealing the vessel with the lid to form the seal preventing oxygen from entering the at least one sealable container; placing the at least one sealable container on a delivery vehicle; and removing the at least one sealable container filled with food wastes from the food permitted establishment with the delivery vehicle. In some embodiments, the methods comprise: after filling the sealable container with the food waste, adding inoculate or acid to the at least one sealable container. In some embodiments, the at least one sealable container is provided to the food permitted establishment nested within other sealable containers. In some embodiments, grinding and mixing the food waste once placed in the vessel of the at least one sealable container is not required due to the small size of the vessel. In some embodiments, a capacity of the vessel is between 10 liters and 200 liters. In some embodiments, the methods comprise: after sealing the at least one sealable container, placing the at least one sealable container outside of the food permitted establishment. In some embodiments, the methods comprise: after placing the at least one sealable container outside of the food permitted establishment, aggregating the at least one sealable container with other sealable containers. In some embodiments, the at least one sealable container is aggregated with the other sealable containers by stacking the sealable containers on a pallet or an open or enclosed cart. In some embodiments, the methods comprise: securing, on the delivery vehicle, the at least one sealable container for load during transportation. In some embodiments, securing the at least one sealable container comprises wrapping the at least one sealable container in shrink wrap, rubber bands, Velcro, or tie downs. In some embodiments, the at least one sealable container comprises a radio-frequency identification (RFID), a barcode, or a near field communication (NFC) chip. In some embodiments, the methods comprise: after sealing the at least one sealable container, scanning the RFID or the barcode to identify a content of the at least one sealable container. In some embodiments, the RFID, the barcode, or the NFC chip is scanned with a smart device. In some embodiments, the methods comprise: delivering, with the delivery vehicle, the at least one sealable container to a facility based on the identified content. In some embodiments, the methods comprise: delivering, with the delivery vehicle, the at least one sealable container to a central facility. In some embodiments, the methods comprise: sorting the at least one sealable container at the central facility based on the identified content. In some embodiments, the at least one sealable container is sorted according to a feedstock property, a potential hydrogen (pH), or an odor, of the identified content. In some embodiments, the methods comprise: performing a pathogen test on the content of the at least one sealable container. In some embodiments, the methods comprise: removing the content of the at least one sealable container at the central facility; and employing the content for at least one of: composting, feeding animals, feeding insects, providing a feedstock for bio based processing, or disposing within landfill. In some embodiments, the methods comprise: cleaning the at least one sealable container in accordance with food safety standards; and drying the at least one sealable container. In some embodiments, the cleaning is performed at an industrial dish washing facility. In some embodiments, the methods comprise: inoculating the at least one sealable container. In some embodiments, inspecting the at least one sealable container. In some embodiments, the food permitted establishment comprises a residence or a business. In some embodiments, the food permitted establishment comprises a kitchen. In some embodiments, the vessel comprises an outer surface modified with the chemical to form the coating resistant to molecule permeation, and the lid comprises a top surface and a bottom surface, the top and bottom lid surfaces modified with the chemical to form the coating resistant to molecule permeation. In some embodiments, the chemical is fluorine, and the inner surface is exposed to a fluorine containing treatment gas from 1 to 60 minutes. In some embodiments, the chemical is fluorine, and the inner surface is exposed to a fluorine containing treatment gas for 30 seconds, 1 minute, 2 min, 5 minutes, 10 minutes, 15 minutes, 20 minutes, 30 minutes, 1 hour, 2 hours, 3 hours, 4 hours, 5 hours, 6 hours, 7 hours, 8 hours, 9 hours, 10 hours, 11 hours, 12 hours, 13 hours, 14 hours, or 15 hours. In some embodiments, the chemical is fluorine, and the inner surface is exposed to a fluorine containing treatment gas for the period of time to form the coating resistant to molecule permeation. In some embodiments, the at least one sealable container comprises plastic. In some embodiments, the at least one sealable container comprises a generally cylindrical shape. In some embodiments, the at least one vertical sidewall comprises four sidewalls, and the vessel and the lid comprise a generally rectangular lateral cross-sectional shape. In some embodiments, the lid comprises a seal ring, and the seal is formed by the seal ring when the lid is attached to the top portion of the at least one vertical sidewall. In some embodiments, the seal ring comprises metal. In some embodiments, In some embodiments, the seal ring comprises rubber. In some embodiments, the at least one vertical sidewall tapers from the top of the vessel to the bottom of the vessel, whereby the at least one sealable container can be stacked on other such containers or the vessel can be nested within another such vessel. In some embodiments, the base portion is formed monolithically with the at least one vertical sidewall. In some embodiments, a capacity of the vessel is between 10 liters and 1000 liters. In some embodiments, the capacity of the vessel is between 10 liters and 200 liters. In some embodiments, the capacity of the vessel is between 10 liters and 50 liters. In some embodiments, the capacity of the vessel is between 50 and 500 liters. In some embodiments, the capacity of the vessel is between 100 and 300 liters. In some embodiments, the lid comprises a vent that allows volatiles to escape as pressure builds up in the at least one sealable container, but does not allow oxygen to enter the at least one sealable container when sealed.

In another aspect, disclosed herein are systems comprising: a sealable container comprising a vessel and a lid, wherein the vessel comprises a base portion and at least one vertical sidewall forming a closed bottom, an inner surface, and an open top for receiving food waste, the inner surface having been exposed to a chemical for a period of time to form a coating resistant to molecule permeation, and wherein the lid is configured to attached to a top portion of the at least one vertical sidewall to cover the open top and form a seal preventing oxygen from entering the sealable container; a food waste production facility, wherein the vessel is filled with food wastes, and the vessel is sealed with the lid after the vessel is filled with the food wastes, at the food waste production facility; a delivery vehicle, wherein the sealable container is placed on the delivery vehicle after filled with the food wastes and sealed with the lid; and a composting facility, wherein the sealable container is delivered, by the delivery vehicle, to the composting facility where the food waste in the sealable container are composted. In some embodiments, the sealable container is delivered to an anaerobic digester, a farm, a charitable organization, or a landfill instead of the composing facility. In some embodiments, the food waste production facility comprises a residence or a business. In some embodiments, after filling the sealable container with the food waste, addinginoculate or acid to the sealable container at the food waste production facility. In some embodiments, the sealable container is provided to the food waste production facility nested within other sealable containers. In some embodiments, grinding and mixing the food waste once placed in the vessel of the sealable container is not required due to the small size of the vessel. In some embodiments, a capacity of the vessel is between 10 liters and 200 liters. In some embodiments, the sealable container is placed outside of the food waste production facility before being placed on the delivery vehicle. In some embodiments, the sealable container is aggregated with other sealable containers when placed outside of the food waste production facility. In some embodiments, the sealable container is aggregated with the other sealable containers by stacking the sealable containers on a pallet or an open or enclosed cart. In some embodiments, the sealable container is secured on the delivery vehicle for load during transportation. In some embodiments, securing the sealable container comprises wrapping the sealable container in shrink wrap, rubber bands, Velcro, or tie downs. In some embodiments, the sealable container comprises a radio-frequency identification (RFID), a barcode, or a near field communication (NFC) chip. In some embodiments, the RFID, the barcode, or the NFC chip is scanned, after the sealable container is sealed with the lid, at the food waste production facility to identify a content of the sealable container. In some embodiments, the RFID, the barcode, or the NFC chip is scanned with a smart device. In some embodiments, the sealable container is sorted at the composting facility based on the identified content. In some embodiments, the sealable container is sorted according to a feedstock property, a potential hydrogen (pH), or an odor, of the identified content. In some embodiments, a pathogen test is performed on the sealable container at the composting facility. In some embodiments, the systems comprise: a washing facility, the sealable container is delivered, by the delivery vehicle after the food waste has been removed, to the washing facility where the sealable container is cleaned in accordance with food safety standards. In some embodiments, the washing facility and the composting facility are the same facility. In some embodiments, the sealable container is inoculated at the washing facility. In some embodiments, the sealable container is inspected at the washing facility and discarded or recycled when found defective. In some embodiments, the food waste production facility comprises a kitchen. In some embodiments, the vessel comprises an outer surface modified with the chemical to form the coating resistant to molecule permeation, and the lid comprises a top surface and a bottom surface, the top and bottom lid surfaces modified with the chemical to form the coating resistant to molecule permeation. In some embodiments, the chemical is fluorine, and the inner surface is exposed to a fluorine containing treatment gas from 1 to 60 minutes. In some embodiments, the chemical is fluorine, and the inner surface is exposed to a fluorine containing treatment gas for 30 seconds, 1 minute, 2 minutes, 5 minutes, 10 minutes, 15 minutes, 20 minutes, 30 minutes, 1 hour, 2 hours, 3 hours, 4 hours, 5 hours, 6 hours, 7 hours, 8 hours, 9 hours, 10 hours, 11 hours, 12 hours, 13 hours, 14 hours, or 15 hours. In some embodiments, the chemical is fluorine, and the inner surface is exposed to a fluorine containing treatment gas for the period of time to form the coating resistant to molecule permeation. In some embodiments, the sealable container comprises plastic. In some embodiments, the sealable container comprises a generally cylindrical shape. In some embodiments, the at least one vertical sidewall comprises four sidewalls, and the vessel and the lid comprise a generally rectangular lateral cross-sectional shape. In some embodiments, the lid comprises a seal ring, and the seal is formed by the seal ring when the lid is attached to the top portion of the at least one vertical sidewall. In some embodiments, the seal ring comprises metal. In some embodiments, the seal ring comprises rubber. In some embodiments, the at least one vertical sidewall tapers from the top of the vessel to the bottom of the vessel, whereby the sealable container can be stacked on another such container or the vessel can be nested within another such vessel. In some embodiments, the base portion is formed monolithically with the at least one vertical sidewall. In some embodiments, a capacity of the vessel is between 10 liters and 1000 liters. In some embodiments, the capacity of the vessel is between 10 liters and 200 liters. In some embodiments, the capacity of the vessel is between 10 liters and 50 liters. In some embodiments, the capacity of the vessel is between 50 and 500 liters. In some embodiments, the capacity of the vessel is between 100 and 300 liters. In some embodiments, the lid comprises a vent that allows volatiles to escape as pressure builds up in the sealable container, but does not allow oxygen to enter the sealable container when sealed.

In another aspect, disclosed herein are sealable containers for evacuation of food waste comprising: a vessel comprising a base portion and at least one vertical sidewall, forming a closed bottom, an inner surface, an outer surface, and an open top for receiving the food waste, the inner surface modified with a chemical to form a coating resistant to molecule permeation; and a lid configured to attached to a top portion of the at least one vertical sidewall to cover the open top and form a seal preventing oxygen from entering the sealable container and creating malodorous compounds. In some embodiments, the vessel and the lid, comprise plastic. In some embodiments, the vessel and the lid, comprise a generally circular lateral cross-sectional shape. In some embodiments, the sealable containers comprise a generally cylindrical shape. In some embodiments, the at least one vertical sidewall comprises four sidewalls, and the vessel and the lid comprise a generally rectangular lateral cross-sectional shape. In some embodiments, the outer surface is modified with the chemical to form the coating resistant to molecule permeation. In some embodiments, the lid comprises a top surface and a bottom surface, the top and bottom lid surfaces modified with the chemical to form the coating resistant to molecule permeation. In some embodiments, the chemical is fluorine, and the inner surface is exposed to a fluorine containing treatment gas for a period of time to form the coating resistant to molecule permeation. In some embodiments, the chemical is fluorine, and the inner surface is exposed to a fluorine containing treatment gas from 1 to 60 minutes. In some embodiments, the chemical is fluorine, and the inner surface is exposed to a fluorine containing treatment gas for 30 seconds, 1 minute, 2 min, 5 minutes, 10 minutes, 15 minutes, 20 minutes, 30 minutes, 1 hour, 2 hours, 3 hours, 4 hours, 5 hours, 6 hours, 7 hours, 8 hours, 9 hours, 10 hours, 11 hours, 12 hours, 13 hours, 14 hours, or 15 hours. In some embodiments, the lid comprises a seal ring, and the seal is formed by the seal ring when the lid is attached to the top portion of the at least one vertical sidewall. In some embodiments, the seal ring comprises metal. In some embodiments, the seal ring comprises rubber. In some embodiments, the at least one vertical sidewall tapers from the top of the vessel to the bottom of the vessel, whereby the sealable container can be stacked on another such container or the vessel can be nested within another such vessel. In some embodiments, the base portion is formed monolithically with the at least one vertical sidewall. In some embodiments, a capacity of the vessel is between 10 liters and 1000 liters. In some embodiments, the capacity of the vessel is between 10 liters and 200 liters. In some embodiments, the capacity of the vessel is between 10 liters and 50 liters. In some embodiments, the capacity of the vessel is between 50 and 500 liters. In some embodiments, the capacity of the vessel is between 100 and 300 liters. In some embodiments, the lid comprises a vent that allows volatiles to escape as pressure builds up in the sealable container, but does not allow oxygen to enter the sealable container when sealed. In some embodiments, the sealable containers comprise a radio-frequency identification (RFID, a barcode, or a near field communication (NFC) chip.

In another aspect, disclosed herein are methods for manufacturing a sealable container for evacuation of food waste comprising: monolithically forming, with a plastic material, a base portion and at least one vertical sidewall of a vessel, the vessel having a closed bottom, an inner surface, an outer surface, and an open top for receiving the food waste; forming, with the plastic material, a lid configured to attached to a top portion of the at least one vertical sidewall to cover the open top and form a seal preventing oxygen from entering the sealable container and creating malodorous compounds; and exposing the inner surface to a fluorine containing treatment gas for a period of time to form a coating resistant to molecule permeation. In some embodiments, the vessel and the lid, comprise a generally circular lateral cross-sectional shape. In some embodiments, the sealable container comprises a generally cylindrical shape. In some embodiments, the at least one vertical sidewall comprises four sidewalls, and wherein the vessel and the lid comprise a generally rectangular lateral cross-sectional shape. In some embodiments, the methods comprise exposing the outer surface to the fluorine containing treatment gas for the period of time to form the coating resistant to molecule permeation. In some embodiments, the lid comprises a top surface and a bottom surface. In some embodiments, the methods comprise exposing the top and bottom lid surfaces to the fluorine containing treatment gas for the period of time to form the coating resistant to molecule permeation. In some embodiments, the period of time is from 1 to 60 minutes. In some embodiments, the period of time is 30 seconds, 1 minute, 2 min, 5 minutes, 10 minutes, 15 minutes, 20 minutes, 30 minutes, 1 hour, 2 hours, 3 hours, 4 hours, 5 hours, 6 hours, 7 hours, 8 hours, 9 hours, 10 hours, 11 hours, 12 hours, 13 hours, 14 hours, or 15 hours. In some embodiments, the lid comprises a seal ring, and wherein the seal is formed by the seal ring when the lid is attached to the top portion of the at least one vertical sidewall. In some embodiments, the seal ring comprises metal. In some embodiments, the seal ring comprises rubber. In some embodiments, the at least one vertical sidewall tapers from the top of the vessel to the bottom of the vessel, whereby the sealable container can be stacked on another such container or the vessel can be nested within another such vessel. In some embodiments, a capacity of the vessel is between 10 liters and 1000 liters. In some embodiments, the capacity of the vessel is between 10 liters and 200 liters. In some embodiments, the vessel is between 10 liters and 50 liters. In some embodiments, the capacity of the vessel is between 50 and 500 liters. In some embodiments, the capacity of the vessel is between 100 and 300 liters. In some embodiments, the methods comprise forming the lid to comprises a vent that allows volatiles to escape as pressure builds up in the sealable container, but does not allow oxygen to enter the sealable container when sealed. In some embodiments, the methods comprise attaching a radio-frequency identification (RFID, a barcode, or a near field communication (NFC) chip to the sealable container.

### BRIEF DESCRIPTION OF THE DRAWINGS

A better understanding of the features and advantages of the present subject matter will be obtained by reference to the following detailed description that sets forth illustrative embodiments and the accompanying drawings of which:

FIGS. 1A and 1B depict isometric perspective views of one embodiment of a sealable container that may be employed within the described food waste removal system.

FIG. 1C depicts a detail-sectional view showing, in greater detail, the vessel of the sealable container.

FIG. 1D depicts a detail-sectional view showing, in greater detail, the upper rim of the sealable container.

FIG. 2 depicts an example environment that can be employed to execute implementations of the described food waste removal system.

FIG. 3 depicts an example kitchen of a food permitted establishment where the described food waste removal system can be employed.

### DETAILED DESCRIPTION OF THE INVENTION

Described herein, in certain embodiments, are methods for evacuating food waste from a food permitted establishment, the method comprising: providing at least one sealable container to the food permitted establishment, wherein the at least one sealable container comprises a vessel and a lid, wherein the vessel comprises a base portion and at least one vertical sidewall forming a closed bottom, an inner surface, and an open top for receiving the food waste, the inner surface having been exposed to a chemical for a period of time to form a coating resistant to molecule permeation, and wherein the lid is configured to attached to a top portion of the at least one vertical sidewall to cover the open top and form a seal preventing oxygen from entering the sealable container; distributing the at least one sealable container within the food permitted establishment where food is going to waste; filling the vessel of the at least one sealable container with the food waste leaving room for gases; sealing the vessel with the lid to form the seal preventing oxygen from entering the at least one sealable container; placing the at least one sealable container on a delivery vehicle; and removing the at least one sealable container filled with food wastes from the food permitted establishment with the delivery vehicle. In some embodiments, the methods comprise: after filling the sealable container with the food waste, adding inoculate or acid to the at least one sealable container.

Also described herein, in certain embodiments, are systems comprising: a sealable container comprising a vessel and a lid, wherein the vessel comprises a base portion and at least one vertical sidewall forming a closed bottom, an inner surface, and an open top for receiving food waste, the inner surface having been exposed to a chemical for a period of time to form a coating resistant to molecule permeation, and wherein the lid is configured to attached to a top portion of the at least one vertical sidewall to cover the open top and form a seal preventing oxygen from entering the sealable container; a food waste production facility, wherein the vessel is filled with food wastes, and the vessel is sealed with the lid after the vessel is filled with the food wastes, at the food waste production facility; a delivery vehicle, wherein the sealable container is placed on the delivery vehicle after filled with the food wastes and sealed with the lid; and a composting facility, wherein the sealable container is delivered, by the delivery vehicle, to the composting facility where the food waste in the sealable container are composted.

Also described herein, in certain embodiments, are sealable containers for evacuation of food waste comprising: a vessel comprising a base portion and at least one vertical sidewall, forming a closed bottom, an inner surface, an outer surface, and an open top for receiving the food waste, the inner surface modified with a chemical to form a coating resistant to molecule permeation; and a lid configured to attached to a top portion of the at least one vertical sidewall to cover the open top and form a seal preventing oxygen from entering the sealable container and creating malodorous compounds. In some embodiments, the vessel and the lid, comprise plastic.

Also described herein, in certain embodiments, are methods for manufacturing a sealable container for evacuation of food waste comprising: monolithically forming, with a plastic material, a base portion and at least one vertical sidewall of a vessel, the vessel having a closed bottom, an inner surface, an outer surface, and an open top for receiving the food waste; forming, with the plastic material, a lid configured to attached to a top portion of the at least one vertical sidewall to cover the open top and form a seal preventing oxygen from entering the sealable container and creating malodorous compounds; and exposing the inner surface to a fluorine containing treatment gas for a period of time to form a coating resistant to molecule permeation

Unless otherwise defined, all technical terms used herein have the same meaning as commonly understood by one of ordinary skill in the art to which this invention belongs.

As used in this specification and the appended claims, the singular forms “a,” “an,” and “the” include plural references unless the context clearly dictates otherwise. Any reference to “or” herein is intended to encompass “and/or” unless otherwise stated.

As used herein, the term “about” refers to an amount that is near the stated amount by 10%, 5%, or 1%, including increments therein.

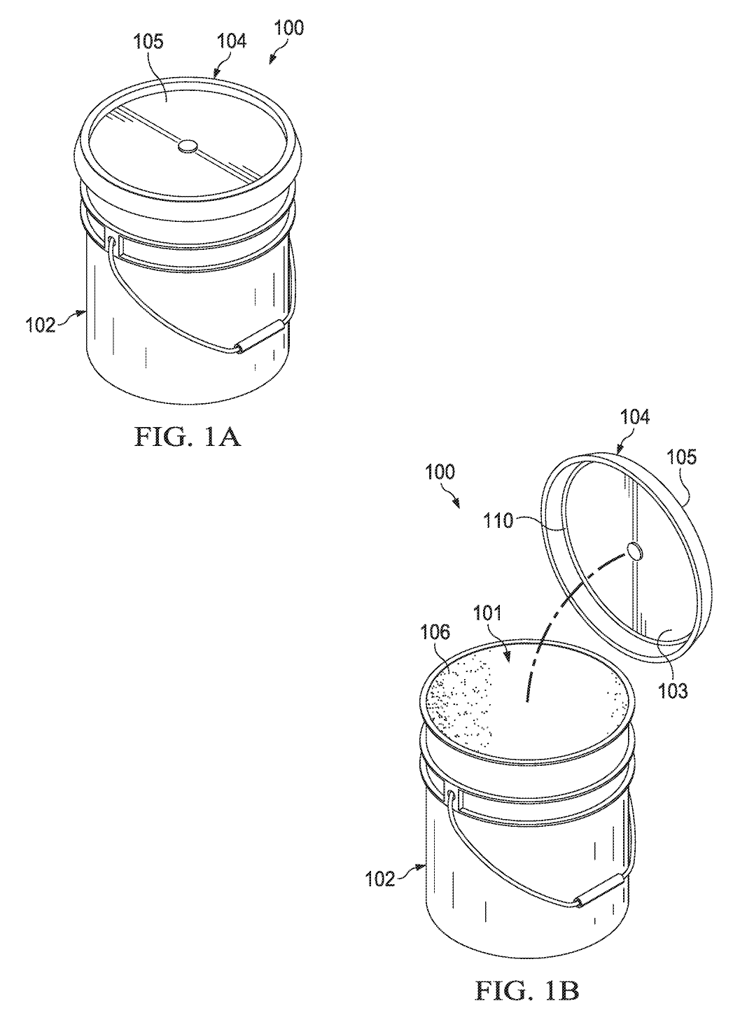

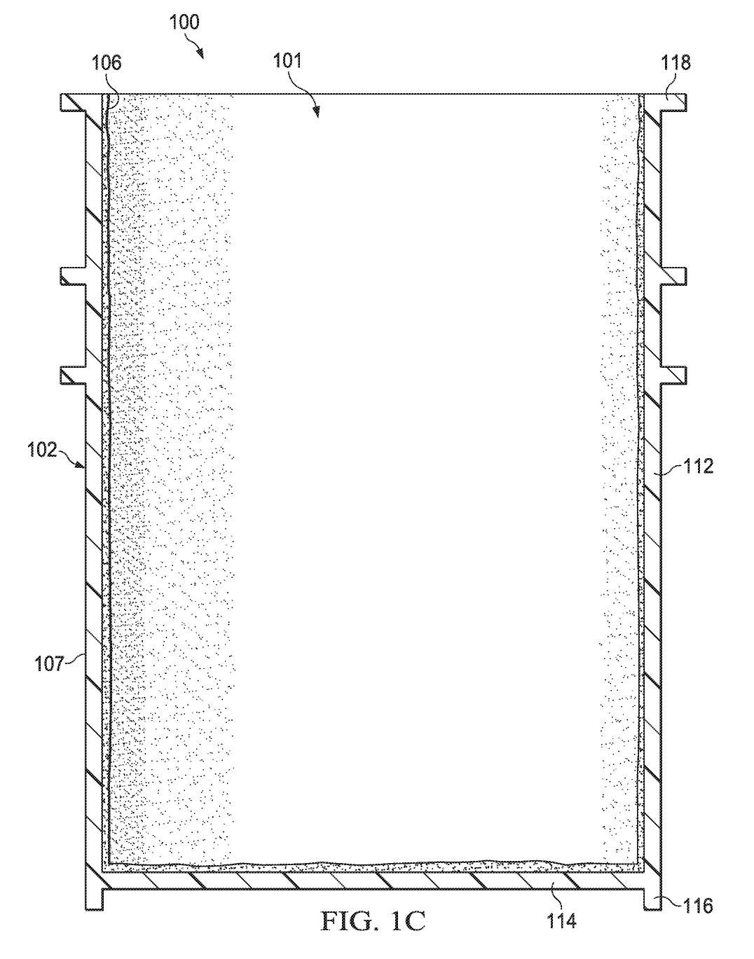

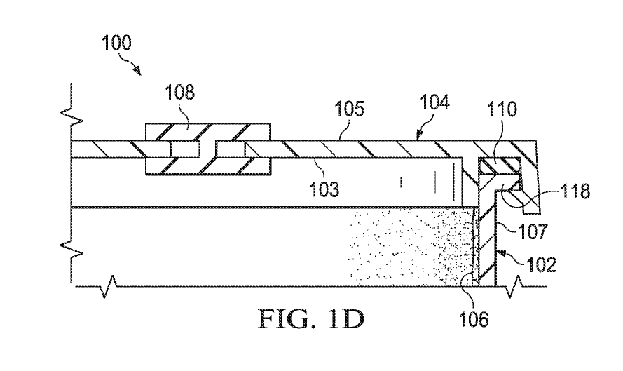

FIGS. 1A and 1B depict isometric perspective views of one embodiment of a sealable container 100 that may be employed within the described food waste removal system. In some embodiments, the sealable container 100 is certified as food grade. As depicted, the sealable container 100 comprises a generally cylindrical shape. As depicted, the sealable container 100 includes a vessel 102 and a lid 104.

FIG. 1A depicts the sealable container 100 with the lid 104 attached to a vessel 102 with an opening 103. FIG. 1B depicts the sealable container 100 with the lid 104 above the vessel 102. In some embodiments, the lid 104 includes a vent 108 (see FIG. 1E) and sealing ring 110. In some embodiments, the lid 104 is configured to attach an upper rim 118 of the vessel 102 so as to form an air-tight seal for the opening 103 with the sealing ring 110. In some embodiments, the inner surface 106 is coated with chemical (see below) to prevent odor and discoloration from building up after repeated exposure to food waste while the sealable container 100 is employed within the described food waste removal system.

In some embodiments, the sealable container 100 is made from any suitable plastic material, such as polypropylene or a high density polyethylene. In some embodiments, the sealable container 100 is made by any suitable conventional molding process. In some embodiments, the sealable container is made from a metal, such as aluminum, brass, bronze, cast iron, cold and hot rolled steel, copper, and stainless steel.

FIG. 1C depicts a detail-sectional view showing, in greater detail, vessel 102 of the sealable container 100 depicted in FIGS. 1A and 1B. As depicted the vessel 102 includes a substantially vertical sidewall 112 and a base portion 114 formed monolithically therewith. The depicted embodiment shows an inner surface 106 and an outer surface 107. In the depicted examples, both the vessel 102 and the lid 104, comprise a generally circular lateral cross-sectional shape. In other examples, a vessel of a sealable container includes four vertical sidewalls and the vessel and the lid comprise a generally rectangular lateral cross-sectional shape.

In some embodiments and as depicted in FIG. 1C, the base portion 114 is spaced slightly above a lower rim 116 of the vessel 102. In such embodiments, the sealable container 100 rests on the lower rim 116, rather than on the base portion 114, to provide a stable footing for the sealable container 100 and prevent damage to the base portion 114. In some embodiments, the sealable container 100 does not include the lower rim 116. In such embodiments, the sealable container rest 100 on the base portion. In some embodiments, the outer diameter of the lower rim 116 is slightly less than the outer diameter of the sidewall 112, the difference in the diameters being selected so as to permit the lower rim 116 to rest on the lid 104, whereby the sealable container 100 can be stacked on top of another container, such as another sealable container 100.

FIG. 1D depicts a detail-sectional view showing, in greater detail, the upper rim of the sealable container 100 depicted in FIGS. 1A and 1B. The lid 104 may be attached to the vessel 102 to form an airtight seal. In the depicted embodiment, a portion of the lid 104 clicks over the upper rim 114 of the vessel 102 creating the air-tight seal with the sealing ring 110. The sealing ring may be comprised of any suitable material to form the airtight seal when the lid 104 is attached to the vessel 104. Such materials include, but are not limit to, rubber neoprene, metal, plastic, paper, silicone, and so forth. Other embodiments of the described sealable container may employ other configuration and mechanisms to fasten the lid 104 to the vessel to form the airtight seal. Such configurations include, for example, a screw lid with a threading mechanism or a anther sort of snapping mechanism.

The vent 108 allows for gases to leave the system but prevents oxygen from entering the sealable container 100 when sealed. The vent 108 provides pressure relief and allows the saleable container 100 to maintain a positive pressure below the set pressure. This helps to prevent the contamination. In some embodiment, the vent 108 comprises an umbrella vent, a Buna vent, or a one-way valve.

In some embodiments, the capacity of the vessel 102 is between 10 liters and 50 liters. This size keeps the overall weight of the sealable container 100 own when filled with food waste so that the container can be moved more easily by workers. Also, as the sealable container 100 is airtight when the lid 104 is placed on the vessel 102, there is a risk that the contents may heat up because of, for example, metabolic activity of bacteria. Some of these bacteria can make the contents unsafe for further treatment as animal feed. Specifically, in case that the temperature is over 140 degrees within an environment lacking oxygen, botulism can grow and release toxic spores. The smaller size of the sealable container 100 helps to controls the amount of organic matter that can be placed in the vessel 102 and helps prevents the organic matter from reaching temperatures that can provide the conditions for botulism and the release of toxic spores.

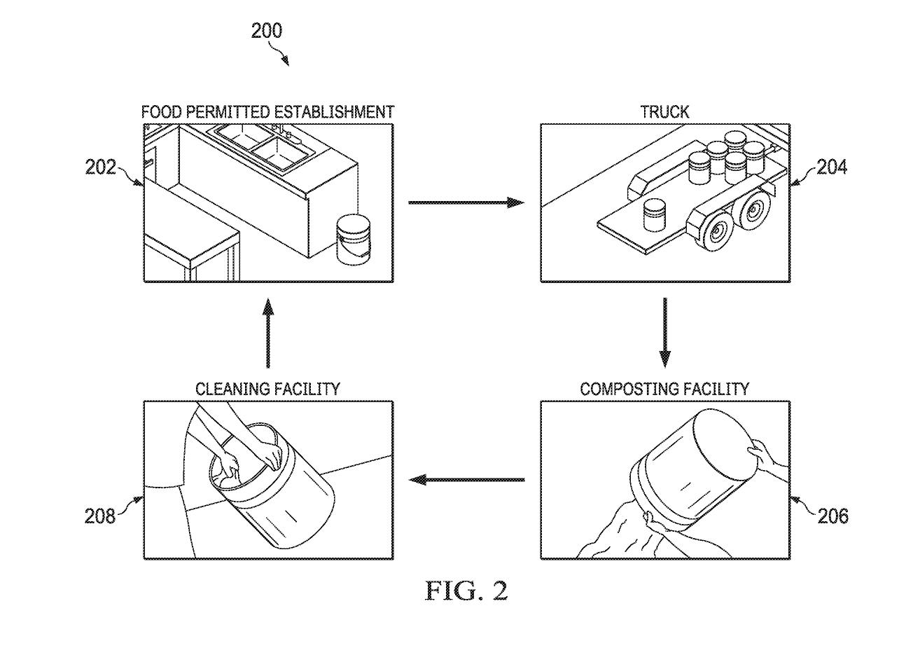

In some embodiments, the sealable container 100 includes a barcode, radio-frequency identification (RFID), or a near field communication (NFC) chip (not shown). The barcode, RFID, or NFC chip may be employed within the described food waste removal system to, for example, identify the contents of the sealable container 100 once food waste has been deposited in the opening. In some embodiments, the barcode, RFID, or NFC chip is used to track and trace the activity f the sealable containers 100 (See FIG. 2). In some embodiments, the sealable containers 100 include one or more stoppers (not shown) that prevent the sealable containers 100 from nesting and getting stuck. In some embodiments, a stopper includes pair of ears that is formed monolithically with the vertical sidewall 112. In some embodiments, each ear is located on a portion of the vertical sidewall 112 diametrically opposite the other ear to form an inverted U-shaped vertical cross section in a plane substantially parallel to a plane which is tangent to a portion of the vertical sidewall 112 adjacent to a corresponding one of the ears. In some embodiments, the barcode, RFID, or NFC chip is placed within the space (e.g., within the inverted U-shape) provided by the stoppers.

In some embodiments, the barcode is an optical, machine-readable representation of data, such as the contents of the sealable container 100. In some embodiments, the barcode systematically represent data by varying the widths and spacings of parallel lines, and may be referred to as linear or one-dimensional (1D). In some embodiments, the barcode include a two-dimensional (2D) variant that uses rectangles, dots, hexagons and other geometric patterns, called matrix codes or 2D barcodes. The barcodes may be scanned by, for example, barcode readers, and devices that can read images, such as a smartphone with camera.

In some embodiments, the RFID includes digital data encoded in an RFID tags or smart labels that may be captured by a reader, such as a smartphone, via radio waves. In some embodiments, RFID uses electromagnetic fields to automatically identify and track tags attached to the sealable container 100. The tags contain electronically stored information, such as the content of the container, a destination of the container, the source of the container, and so forth. In some embodiments, the RFID may include passive tags that collect energy from a nearby RFID reader's interrogating radio waves. In some embodiments, the employed RFID may include active tags that have a local power source, such as a battery, and operate hundreds of meters from an RFID reader. RFID may be employed in the described food waste removal system because the RFID tag data can be read outside the line-of-sight, whereas barcodes must be aligned with an optical scanner. Unlike a barcode, the tag need not be within the line of sight of the reader. As such, the RFID can be embedded in the sealable container 100.

In some embodiments, the NFC chip operates as one part of a wireless link that may be activated by another chip, for example, within a smartphone. Once activated, small amounts of data between the two chips can be transferred when held within, for example, a few centimeters from each other. As such, the NFC chip can be embedded in the sealable container 100.

In certain embodiments, provided herein the surfaces of the sealable container 100 are coated by one or more chemicals. In some embodiments, provided herein the inner surface 106 of the vessel 102 is coated by one or more chemicals. In some embodiments, provided herein the outer surface 107 of the vessel 102 is coated by one or more chemicals. In some embodiments, provided herein the inner surface 106 and an outer surface 107 of the vessel 102 are coated by one or more chemicals. In some embodiments, one or more surfaces of the lid 104 (e.g., the top surface 105 and a bottom surface 103) are coated by one or more chemicals.

In some embodiments, provided herein the sealable container 100 is coated by one or more chemicals, wherein one or more chemicals is a fluorinating reagent. In some embodiments, the fluorinating reagent is fluorine. In some embodiments, the fluorinating reagent is selected from HF, KF, CsF, Bu₄NF, 2,2-difluoro-1,3-dimethylimidazolidine, diethylaminosulfur trifluoride, and any combination thereof. In some embodiments, the fluorinating reagent is selected from N-fluoro-pyridinium salt, N-fluoro-N′-(chloromethyl)triethylenediamine bis(tetrafluoro-borate), N-fluorobenzenesulfonimide, and any combination thereof. In some embodiments, the sealable container 100 is coated by one or more chemicals at a temperature to set a reactivity of the gases to form the coating.

In some embodiments, the sealable container 100 comprises a polymer-based container. In some embodiments, the polymer-based container comprises a plastic. In some embodiments, the polymer-based container comprises a polyolefinic container. In some embodiments, the polyolefinic container comprises a modified with polyethylene (PE), polypropylene (PP), polyamide (PA), polytetrafluoroethylene (PTFE), polyvinylidene fluoride (PVdF), polyvinyl chloride (PVC), or a combination thereof. In some embodiments, the sealable container 100 comprises a microporous container or a nonwoven container. In some embodiments, the sealable container 100 comprises a carbon-based container comprising a moiety capable of being modified by one or more chemicals. In some embodiments, the carbon-based container comprises a polymer moiety. In some embodiments, the carbon-based container comprises a carbon-based polymer. In some embodiments, the carbon-based container comprises a polyolefin moiety. In some embodiments, the polyolefin moiety comprises a polyethylene (PE) moiety, a polypropylene (PP) moiety, a polyamide (PA) moiety, a polytetrafluoroethylene (PTFE) moiety, a polyvinylidene fluoride (PVdF) moiety, or a polyvinyl chloride (PVC) moiety.

In some embodiments, the sealable container 100 comprises a carbon-based container. In some embodiments, the carbon-based container comprises a plastic. In some embodiments, the carbon-based container comprises a carbon-based polymer. In some embodiments, the carbon-based container comprises a polyolefin moiety. In some embodiments, the polyolefin moiety comprises polyethylene moiety, polypropylene moiety, polyvinyl chloride moiety, polyvinylidene fluoride moiety, polytetrafluoroethylene moiety, polychlorotrifluoroethylene moiety, or polystyrene moiety. In some embodiments, the carbon-based polymer comprises polyamide moiety, polyurethane moiety, phenol-formaldehyde resin moiety, polycarbonate moiety, polychloroprene moiety, polyacrylonitrile moiety, polimide moiety, or polyester moiety. In some embodiments, the carbon-based polymer comprises nylon. In some embodiments, the carbon-based polymer comprises polyethylene terephthalate.

In some embodiments, the sealable container 100 comprises a silicon-based container. In some embodiments, the silicon-based container comprises a silicon-based polymer moiety. In some embodiments, the sealable container 100 comprises a silicon-based container comprising a moiety capable of being modified by one or more chemicals. In some embodiments, the silicon-based container comprises a polymer moiety. In some embodiments, the silicon-based container comprises a siloxane polymer moiety, a sesquisiloxane polymer moiety, a siloxane-silarylene polymer moiety, a silalkylene polymer moiety, a polysilane moiety, a polysilylene moiety, or a polysilazane moiety. In some embodiments, the silicon-based container comprises a siloxane polymer moiety.

In some embodiments, the silicon-based container comprises silicone polymer. In some embodiments, the silicon-based container comprises a silicone-based container.

In some embodiments, the sealable container 100 comprises a carbon-based container or a silicon-based container.

In some embodiments, the sealable container 100 described herein coated by one or more chemicals leads to a reduced molecule permeation relative to a container not coated by one or more chemicals. In some instances, the reduced molecule permeation is by about 10%, 20%, 30%, 40%, 50%, 60%, 70%, 80%, 90%, 95%, 99%, 99.5%, 99.9%, 99.99% or more relative to a container not coated by one or more chemicals. In some instances, the reduced molecule permeation is by about 10%, or more relative to a container not coated by one or more chemicals. In some instances, the reduced molecule permeation is by about 20%, or more relative to a container not coated by one or more chemicals. In some instances, the reduced molecule permeation is by about 30%, or more relative to a container not coated by one or more chemicals. In some instances, the reduced molecule permeation is by about 40%, or more relative to a container not coated by one or more chemicals. In some instances, the reduced molecule permeation is by about 50%, or more relative to a container not coated by one or more chemicals. In some instances, the reduced molecule permeation is by about 60%, or more relative to a container not coated by one or more chemicals. In some instances, the reduced molecule permeation is by about 70%, or more relative to a container not coated by one or more chemicals. In some instances, the reduced molecule permeation is by about 80%, or more relative to a container not coated by one or more chemicals. In some instances, the reduced molecule permeation is by about 90%, or more relative to a container not coated by one or more chemicals. In some instances, the reduced molecule permeation is by about 95%, or more relative to a container not coated by one or more chemicals. In some instances, the reduced molecule permeation is by about 99%, or more relative to a container not coated by one or more chemicals. In some instances, the reduced molecule permeation is by about 99.5%, or more relative to a container not coated by one or more chemicals. In some instances, the reduced molecule permeation is by about 99.9%, or more relative to a container not coated by one or more chemicals. In some instances, the reduced molecule permeation is by about 99.99%, or more relative to a container not coated by one or more chemicals.

In some embodiments, a portion of the surfaces up to and including all of the surfaces of the sealable container 100, such as the inner surface 106 of the vessel 102, the outer surface 107 of the vessel 107, the bottom surface 103 of the lid 104, and the top surface 105 of the lid 104, are exposed to a fluorinating reagent for a period of time to form the coating resistant to molecule permeation. In some embodiments, the surfaces of the sealable container 100 are exposed to a fluorinating reagent from 1 to 60 minutes to form the coating resistant to molecule permeation. In some embodiments, the surfaces of the sealable container 100 are exposed to a fluorinating reagent for 30 sec, 1 min, 2 min, 5 min, 10 min, 15 min, 20 min, or 30 min to form the coating resistant to molecule permeation. In some embodiments, the surfaces of the sealable container 100 are exposed to a fluorinating reagent for 1 hour, 2 hours, 3 hours, 4 hours, 5 hours, 6 hours, 7 hours, 8 hours, 9 hours, 10 hours, 11 hours, 12 hours, 13 hours, 14 hours, or 15 hours to form the coating resistant to molecule permeation. In some embodiments, the surfaces of the sealable container 100 are exposed to a fluorinating reagent for 30 sec to form the coating resistant to molecule permeation. In some embodiments, the surfaces of the sealable container 100 are exposed to a fluorinating reagent for 1 min to form the coating resistant to molecule permeation. In some embodiments, the surfaces of the sealable container 100 are exposed to a fluorinating reagent for 2 min to form the coating resistant to molecule permeation. In some embodiments, the surfaces of the sealable container 100 are exposed to a fluorinating reagent for 5 min to form the coating resistant to molecule permeation. In some embodiments, the surfaces of the sealable container 100 are exposed to a fluorinating reagent for 10 min to form the coating resistant to molecule permeation. In some embodiments, the surfaces of the sealable container 100 are exposed to a fluorinating reagent for 15 min to form the coating resistant to molecule permeation. In some embodiments, the surfaces of the sealable container 100 are exposed to a fluorinating reagent for 20 min to form the coating resistant to molecule permeation. In some embodiments the surfaces of the sealable container 100 are exposed to a fluorinating reagent for 25 min to form the coating resistant to molecule permeation. In some embodiments, the surfaces of the sealable container 100 are exposed to a fluorinating reagent for 30 min to form the coating resistant to molecule permeation. In some embodiments, the surfaces of the sealable container 100 are exposed to a fluorinating reagent for between 1 hour and 15 hours.

In some embodiments, the inner surface 106 of the vessel 102 is exposed to a fluorinating reagent for a period of time to form the coating resistant to molecule permeation. In some embodiments, the inner surface 106 is exposed to a fluorinating reagent from 1 to 60 minutes to form the coating resistant to molecule permeation. In some embodiments, the inner surface 106 is exposed to a fluorinating reagent for 30 sec, 1 min, 2 min, 5 min, 10 min, 15 min, 20 min, or 30 min to form the coating resistant to molecule permeation. In some embodiments, the inner surface 106 is exposed to a fluorinating reagent for 1 hour, 2 hours, 3 hours, 4 hours, 5 hours, 6 hours, 7 hours, 8 hours, 9 hours, 10 hours, 11 hours, 12 hours, 13 hours, 14 hours, or 15 hours to form the coating resistant to molecule permeation. In some embodiments, the inner surface 106 is exposed to a fluorinating reagent for 30 sec to form the coating resistant to molecule permeation. In some embodiments, the outer surface is exposed to a fluorinating reagent for 1 min to form the coating resistant to molecule permeation. In some embodiments, the inner surface 106 is exposed to a fluorinating reagent for 2 min to form the coating resistant to molecule permeation. In some embodiments, the inner surface 106 is exposed to a fluorinating reagent for 5 min to form the coating resistant to molecule permeation. In some embodiments, the inner surface 106 is exposed to a fluorinating reagent for 10 min to form the coating resistant to molecule permeation. In some embodiments, the inner surface 106 is exposed to a fluorinating reagent for 15 min to form the coating resistant to molecule permeation. In some embodiments, the inner surface 106 is exposed to a fluorinating reagent for 20 min to form the coating resistant to molecule permeation. In some embodiments, the inner surface 106 is exposed to a fluorinating reagent for 25 min to form the coating resistant to molecule permeation. In some embodiments, the inner surface 106 is exposed to a fluorinating reagent for 30 min to form the coating resistant to molecule permeation. In some embodiments, the inner surface 106 is exposed to a fluorinating reagent for between 1 hour and 15 hours.

In some embodiments, the outer surface 107 of the vessel 102 is exposed to a fluorinating reagent for a period of time to form the coating resistant to molecule permeation. In some embodiments, the outer surface 107 is exposed to a fluorinating reagent from 1 to 60 minutes to form the coating resistant to molecule permeation. In some embodiments, the outer surface 107 is exposed to a fluorinating reagent for 30 sec, 1 min, 2 min, 5 min, 10 min, 15 min, 20 min, or 30 min to form the coating resistant to molecule permeation. In some embodiments, the outer surface 107 is exposed to a fluorinating reagent for 1 hour, 2 hours, 3 hours, 4 hours, 5 hours, 6 hours, 7 hours, 8 hours, 9 hours, 10 hours, 11 hours, 12 hours, 13 hours, 14 hours, or 15 hours to form the coating resistant to molecule permeation. In some embodiments, the outer surface 107 is exposed to a fluorinating reagent for 30 sec to form the coating resistant to molecule permeation. In some embodiments, the outer surface 107 is exposed to a fluorinating reagent for 1 min to form the coating resistant to molecule permeation. In some embodiments, the outer surface 107 is exposed to a fluorinating reagent for 2 min to form the coating resistant to molecule permeation. In some embodiments, the outer surface 107 is exposed to a fluorinating reagent for 5 min to form the coating resistant to molecule permeation. In some embodiments, the outer surface 107 is exposed to a fluorinating reagent for 10 min to form the coating resistant to molecule permeation. In some embodiments, the outer surface 107 is exposed to a fluorinating reagent for 15 min to form the coating resistant to molecule permeation. In some embodiments, the outer surface 107 is exposed to a fluorinating reagent for 20 min to form the coating resistant to molecule permeation. In some embodiments, the outer surface 107 is exposed to a fluorinating reagent for 25 min to form the coating resistant to molecule permeation. In some embodiments, the outer surface 107 is exposed to a fluorinating reagent for 30 min to form the coating resistant to molecule permeation. In some embodiments, the outer surface 107 is exposed to a fluorinating reagent for between 1 hour and 15 hours.

In some embodiments, the top surface 105 of the lid 104 is exposed to a fluorinating reagent for a period of time to form the coating resistant to molecule permeation. In some embodiments, the top surface 105 is exposed to a fluorinating reagent from 1 to 60 minutes to form the coating resistant to molecule permeation. In some embodiments, the top surface 105 is exposed to a fluorinating reagent for 30 sec, 1 min, 2 min, 5 min, 10 min, 15 min, 20 min, or 30 min to form the coating resistant to molecule permeation. In some embodiments, the top surface 105 is exposed to a fluorinating reagent for 1 hour, 2 hours, 3 hours, 4 hours, 5 hours, 6 hours, 7 hours, 8 hours, 9 hours, 10 hours, 11 hours, 12 hours, 13 hours, 14 hours, or 15 hours to form the coating resistant to molecule permeation. In some embodiments, the top surface 105 is exposed to a fluorinating reagent for 30 sec to form the coating resistant to molecule permeation. In some embodiments, the top surface 105 is exposed to a fluorinating reagent for 1 min to form the coating resistant to molecule permeation. In some embodiments, the top surface 105 is exposed to a fluorinating reagent for 2 min to form the coating resistant to molecule permeation. In some embodiments, the top surface 105 is exposed to a fluorinating reagent for 5 min to form the coating resistant to molecule permeation. In some embodiments, the top surface 105 is exposed to a fluorinating reagent for 10 min to form the coating resistant to molecule permeation. In some embodiments, the top surface 105 is exposed to a fluorinating reagent for 15 min to form the coating resistant to molecule permeation. In some embodiments, the top surface 105 is exposed to a fluorinating reagent for 20 min to form the coating resistant to molecule permeation. In some embodiments, the top surface 105 is exposed to a fluorinating reagent for 25 min to form the coating resistant to molecule permeation. In some embodiments, the top surface 105 is exposed to a fluorinating reagent for 30 min to form the coating resistant to molecule permeation. In some embodiments, the top surface 105 is exposed to a fluorinating reagent for between 1 hour and 15 hours.

In some embodiments, the bottom surface 103 of the lid 104 is exposed to a fluorinating reagent for a period of time to form the coating resistant to molecule permeation. In some embodiments, the bottom surface 103 is exposed to a fluorinating reagent from 1 to 60 minutes to form the coating resistant to molecule permeation. In some embodiments, the bottom surface 103 is exposed to a fluorinating reagent for 30 sec, 1 min, 2 min, 5 min, 10 min, 15 min, 20 min, or 30 min to form the coating resistant to molecule permeation. In some embodiments, the bottom surface 103 is exposed to a fluorinating reagent for 1 hour, 2 hours, 3 hours, 4 hours, 5 hours, 6 hours, 7 hours, 8 hours, 9 hours, 10 hours, 11 hours, 12 hours, 13 hours, 14 hours, or 15 hours to form the coating resistant to molecule permeation. In some embodiments, the bottom surface 103 is exposed to a fluorinating reagent for 30 sec to form the coating resistant to molecule permeation. In some embodiments, the bottom surface 103 is exposed to a fluorinating reagent for 1 min to form the coating resistant to molecule permeation. In some embodiments, the bottom surface 103 is exposed to a fluorinating reagent for 2 min to form the coating resistant to molecule permeation. In some embodiments, the bottom surface 103 is exposed to a fluorinating reagent for 5 min to form the coating resistant to molecule permeation. In some embodiments, the bottom surface 103 is exposed to a fluorinating reagent for 10 min to form the coating resistant to molecule permeation. In some embodiments, the bottom surface 103 is exposed to a fluorinating reagent for 15 min to form the coating resistant to molecule permeation. In some embodiments, the bottom surface 103 is exposed to a fluorinating reagent for 20 min to form the coating resistant to molecule permeation. In some embodiments, the bottom surface 103 is exposed to a fluorinating reagent for 25 min to form the coating resistant to molecule permeation. In some embodiments, the bottom surface 103 is exposed to a fluorinating reagent for 30 min to form the coating resistant to molecule permeation. In some embodiments, the bottom surface 103 is exposed to a fluorinating reagent for between 1 hour and 15 hours.

FIG. 2 depicts an example environment 200 that can be employed to execute implementations of the described food waste removal system. The example environment 200 includes a food permitted establishment 202, a delivery vehicle 204, a composing facility 206, and an industrial washing facility 208. In some embodiments, a food permitted establishment 202 includes a kitchen in a residence or a business such an industrial kitchen at a food production facility. Other food permitted establishments include restaurants, grocery stores, or any other facility that produces food waste (e.g., a food waste production facility). In some embodiments, the delivery vehicle 204 includes various types of trucks, vans, cars, boats, and planes, capable of transporting the sealable containers, such as sealable container 100, to the various facilities within the described food waste removal system. In some embodiments, the composting facility 206 includes a structure or device that uses controlled aerobic decomposition to transform waste organic material, such as food waste, into a biologically stable product that can be used as a soil amendment. In some embodiments of the described food waste removal system, other types of facilities maybe employed as a destination for the food waste collected within the sealable containers from the food permitted establishment, such as an anaerobic digester, a farm, a charitable organization, or a landfill. In some embodiments, industrial washing facility 208 includes a facility where the sealable containers may be cleaned, inspected, and/or inoculated before shipment back the a food permitted establishment 202.

In an example process of the food waste removal system employed within the example environment 200, food waste and grease is collected in the reusable, sealable containers, such as sealable containers 100. In some embodiments, such containers are easy to clean, provided an airtight container for collection, and include inner coated surface to prevent the buildup of odor and discoloration from multiple usages. In the example process, clean or sanitized sealable containers are picked up from the industrial washing facility 208 for delivery to a food permitted establishment 202 via the delivery vehicle 204. In some embodiments, the maximum volume of sealable containers is 50 liters. In some embodiments, the maximum volume of sealable containers is 200 liters. Other sizes of the sealable containers may be employed based on the needs or the preferences of the food permitted establishment 202. In some embodiments, Lactobacillus, food grade acids or other-substance, that enhances the speed of fermentation inside the containers is added after the containers have been cleaned or sanitized. In some embodiments, fermentation starter materials can be added after the containers are cleaned or sanitized but they can also be used when the containers are being filled or before they are sealed.

Continuing with the example process employed within the example environment 200, the sealable containers are delivered to the food permitted establishment 202 as an individual item or nested with multiple other collection devices and lids via the delivery vehicle 204. An operator at the food permitted establishment 202 places one or more of the sealable containers at various places where food is going to waste within the workflow of the food permitted establishment 202. Operators working in the food permitted establishment 202, such as chefs, food handlers, and dish washers, fill the sealable containers with food before it turns into waste right at, for example, their workstation. In some embodiments, the operators fill sealable containers with food waste, leaving some room for gasses on top. In some embodiments, additional inoculate or acid is added to the sealable container. In some embodiments, because of small size factor of sealable containers, grinding and mixing of the content is not required. In some embodiments, sealable containers are sealed with the lid to prevent oxygen from entering the container and creating malodorous compounds. As described above in FIG. 1D, the lid include a vent that allows volatiles to escape as pressure builds up, but doesn't allow oxygen to enter the sealed container. In some embodiments, the operators scan an RFID, NIC chip, or Barcode with reader or a smart device, such as smartphone to identify the content of what was placed in the respective sealable container. In some embodiments, the operator brings the sealed containers outdoors to await collection. In some embodiments, the containers are sealed after they are brought outside. In some embodiments and as described above, the shape of the sealable containers allows for them aggregated together in stacks or on pallets or carts simplifying the logistics for hauling. Additional means of aggregating the sealable containers for transport can include shrink wrap, rubber bands, Velcro, tie downs, to secure the load during transportation on the delivery vehicle 204.

Continuing with the example process employed within the example environment 200, the aggregated sealable containers that container food waste are picked up and placed onto the delivery vehicle 204 for transport. Because the sealable containers lock in odors and prevent oxidation that causes bad odors, the frequency of pickups can be reduced. For example, as long as the sealable containers are picked up within a month, the containers can be preserved for animal feed to invertebrates, vertebrates, or composting. The sealable containers are delivered to the destination facility, such as the composing facility 206.

Continuing with the example process employed within the example environment 200, at the destination facility, the aggregated sealable containers can be further sorted and then re-aggregation or directly to a customer as appropriate. For example, a sealable container may be sorted based on its contents. In some embodiments, the information for a sealable container's contents may be provided by the barcode, NFC chip, or RFID read a reader or smart device. Examples of the types of sorting that can be performed at the destination facility based on the information read from the barcode, NFC chip, or RFID include, but are not limited to, sorting according to Barcode, sorting according feedstock properties, sorting according to potential of Hydrogen (pH), sorting according to odor, sorting according to volatile, sorting according to temperature conditions, sorting according to temperature requirements history, sorting according to pathogen testing, or sorting according to legal requirements (e.g., whether the contents meets federal, regional, state, or local law, whether the contents can be recycled or fed to animals, and so forth). In some embodiments, the contents of the aggregated sealable containers can be used at the destination facility to make, for example, compost (e.g., at the composting facility 206), animal animals, feed for insects, a feedstock for bio based processing like anaerobic digestion. In some embodiments, the contents may be disposed of within landfill if, for example, no other user can be found or is allowed. As an example, appropriate measures can be taken, such as using the material for an intended purpose, discarding the material, or further testing, when the information regarding the contents of a sealable container indicate the presence of pathogens, that the contents do not reach a desired pH, a certain odor, a certain volatile compound, evidence that a temperature requirements has not been met (e.g., during transport).

Continuing with the example process employed within the example environment 200, the sealable containers, once emptied, can be aggregated. In some embodiments, the emptied sealable containers can be picked up by the delivery vehicle 204 and transported to the industrial washing facility 208. In other embodiments, the washing facility 208 may be at the same location as the destination facility. In such embodiments, the emptied sealable container would not be transported (other than internal transport within the common facility). In some embodiments, the sealable containers are cleaned are accordance with food safety standards and followed by a drying step at the industrial washing facility 208. In some embodiments, the sealable containers are clean to such a degree that they can be placed in a commercial kitchen in accordance to, for example, local and state ordnances and regulations. In some embodiments, the sealable containers are inoculated, for example, when making animal feed. In some embodiments the sealable containers are inoculated with bacteria or acids on the cleaned inner surfaces (e.g., inner surface 106) as a way of inoculating the food once it is placed into the sealable container to assure feed safety. As described above, In some embodiments, Lactobacillus, food grade acids or other-substance, that enhances the speed of fermentation inside the cleaned containers is added. In some embodiments, the sealable containers are inspected, and broken containers are discarded or recycled. In some embodiments, the cleaned containers are aggregated for distribution back to the food permitted establishment 202 or another food permitted establishment.

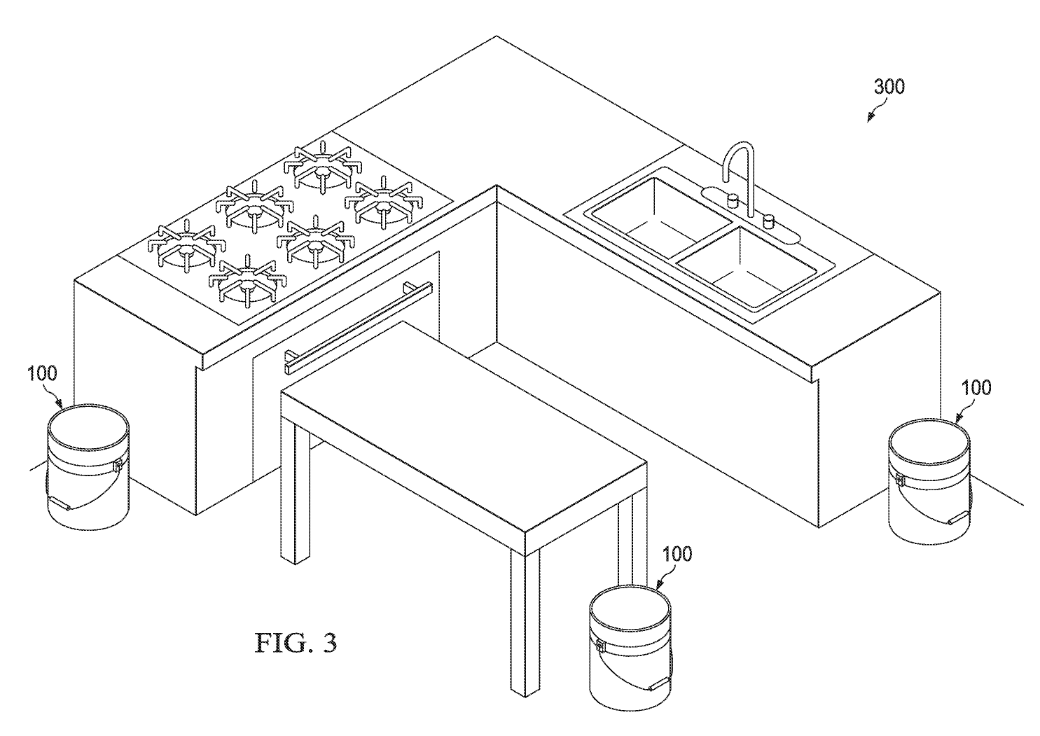

FIG. 3 depicts an example kitchen 300 of a food permitted establishment, such as the food permitted establishment 202 of FIG. 2, where the described food waste removal system can be employed. As depicted the sealable containers 100 are deployed to where food is going to waste within the workflow of the food permitted establishment 202. In the depicted example kitchen 300, operators fill the sealable containers 100 with food waste at, for example, their workstation. In some embodiments, the operators fill sealable containers with food waste, leaving some room for gasses on top. In some embodiments, additional inoculate or acid is added to the sealable container. In some embodiments, because of small size factor of sealable containers, grinding and mixing of the content is not required. In some embodiments, sealable containers are sealed with the lid to prevent oxygen from entering the container and creating malodorous compounds. In some embodiments, the operator brings the sealed containers outdoors to await collection.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described earlier as acting in certain combinations and even initially claimed as such, one or more features from a claimed combination can in some cases be excised from the combination, and the claimed combination may be directed to a sub-combination or variation of a sub-combination.

Particular implementations and embodiments of the subject matter have been described. Other implementations, embodiments, alterations, and permutations of the described implementations and embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

What is claimed is:

1. A method for evacuating food waste from a food permitted establishment, the method comprising:
providing at least one sealable container to the food permitted establishment, wherein the at least one sealable container comprises a vessel and a lid, wherein the vessel comprises a base portion and at least one vertical sidewall forming a closed bottom, an inner surface, and an open top for receiving the food waste, the inner surface having been exposed to a chemical for a period of time to form a coating resistant to molecule permeation, and wherein the lid is configured to attached to a top portion of the at least one vertical sidewall to cover the open top and form a seal preventing oxygen from entering the sealable container;
distributing the at least one sealable container within the food permitted establishment where food is going to waste;
filling the vessel of the at least one sealable container with the food waste leaving room for gases;
sealing the vessel with the lid to form the seal preventing oxygen from entering the at least one sealable container;
placing the at least one sealable container on a delivery vehicle; and
removing the at least one sealable container filled with food wastes from the food permitted establishment with the delivery vehicle.

2. The method of claim 1, comprising:
after filling the sealable container with the food waste, adding inoculate or acid to the at least one sealable container.

3. The method of claim 1, wherein the at least one sealable container is provided to the food permitted establishment nested within other sealable containers.

4. The method of claim 1, wherein a capacity of the vessel is between 10 liters and 200 liters.

5. The method of claim 4, wherein grinding and mixing the food waste once placed in the vessel of the at least one sealable container is not required due to the small size of the vessel.

6. The method of claim 1, comprising:
after sealing the at least one sealable container, placing the at least one sealable container outside of the food permitted establishment, and
aggregating the at least one sealable container with other sealable containers, wherein the at least one sealable container is aggregated with the other sealable containers by stacking the sealable containers on a pallet or an open or enclosed cart.

7. The method of claim 1, wherein the at least one sealable container comprises a radio-frequency identification (RFID), a barcode, or a near field communication (NFC) chip, and wherein the method comprises:
after sealing the at least one sealable container, scanning the RFID or the barcode to identify a content of the at least one sealable container, and
delivering, with the delivery vehicle, the at least one sealable container to a facility based on the identified content.

8. The method of claim 7, comprising:
sorting the at least one sealable container at the facility based on the identified content, wherein the at least one sealable container is sorted according to a feedstock property, a potential hydrogen (pH), or an odor, of the identified content.

9. The method of claim 8, comprising:
removing the content of the at least one sealable container at the facility; and
employing the content for at least one of: composting, feeding animals, feeding insects, providing a feedstock for bio based processing, or disposing within landfill.

10. The method of claim 9, comprising:
cleaning the at least one sealable container in accordance with food safety standards; and
drying the at least one sealable container.

11. The method of claim 10, comprising:
inoculating the at least one sealable container.

12. The method of claim 1, wherein the vessel comprises an outer surface modified with the chemical to form the coating resistant to molecule permeation, and wherein the lid comprises a top surface and a bottom surface, the top and bottom lid surfaces modified with the chemical to form the coating resistant to molecule permeation.

13. The method of claim 1, wherein the chemical is fluorine, and wherein the inner surface is exposed to a fluorine containing treatment gas for the period of time to form the coating resistant to molecule permeation.

14. A sealable container for evacuation of food waste comprising:
a vessel comprising a base portion and at least one vertical sidewall, forming a closed bottom, an inner surface, an outer surface, and an open top for receiving the food waste, the inner surface modified with a chemical to form a coating resistant to molecule permeation; and
a lid configured to attached to a top portion of the at least one vertical sidewall to cover the open top and form a seal preventing oxygen from entering the sealable container and creating malodorous compounds.

15. The sealable container of claim 1, wherein the vessel and the lid, comprise a generally circular lateral cross-sectional shape, and wherein the at least one vertical sidewall tapers from the open top of the vessel to the closed bottom of the vessel, whereby the sealable container can be stacked on another such container or the vessel can be nested within another such vessel.

16. The sealable container of claim 1, wherein the vessel and the lid, comprise plastic; and wherein the lid comprises a bottom surface, the bottom surface modified with the chemical to form the coating resistant to molecule permeation.

17. The sealable container of claim 1, wherein the chemical is fluorine, and wherein the inner surface is exposed to a fluorine containing treatment gas for a period of time to form the coating resistant to molecule permeation.

18. The sealable container of claim 1, wherein the lid comprises a rubber seal ring, and wherein the seal is formed by the rubber seal ring when the lid is attached to the top portion of the at least one vertical sidewall.

19. The sealable container of claim 1, wherein the lid comprises a vent that allows volatiles to escape as pressure builds up in the sealable container, but does not allow oxygen to enter the sealable container when sealed.

20. A system comprising:
a sealable container comprising a vessel and a lid, wherein the vessel comprises a base portion and at least one vertical sidewall forming a closed bottom, an inner surface, and an open top for receiving food waste, the inner surface having been exposed to a chemical for a period of time to form a coating resistant to molecule permeation, and wherein the lid is configured to attached to a top portion of the at least one vertical sidewall to cover the open top and form a seal preventing oxygen from entering the sealable container;
a food waste production facility, wherein the vessel is filled with food wastes, and the vessel is sealed with the lid after the vessel is filled with the food wastes, at the food waste production facility;
a delivery vehicle, wherein the sealable container is placed on the delivery vehicle after filled with the food wastes and sealed with the lid; and
a composting facility, wherein the sealable container is delivered, by the delivery vehicle, to the composting facility where the food waste in the sealable container are composted.
